(19) United States
(12) Patent Application Publication
(10) Pub. No.: US 2022/0129417 A1
(43) Pub. Date: Apr. 28, 2022

(54) Code Similarity Search

(71) Applicant: Google LLC, Mountain View, CA (US)

(72) Inventors: Juan Infantes Diaz, Mountain View, CA (US); Emiliano Martinez, Mountain View, CA (US)

(73) Assignee: Google LLC, Mountain View, CA (US)

(21) Appl. No.: 17/076,985

(22) Filed: Oct. 22, 2020

(51) Int. Cl. G06F 16/14; G06F 16/13; H04L 9/06; G06F 8/70

(52) U.S. Cl. CPC G06F 16/152; G06F 8/70; H04L 9/0643; G06F 16/137

(57) ABSTRACT

A method for determining code similarity includes receiving a file, identifying executable portions of the file, dividing the executable portions of the file into code blocks, generating a hash to represent each code block, and storing the file in a database as a sequence of the hashes representing the code blocks. The method further includes receiving a query to identify whether a first file stored in the database is similar to any other file stored in the database. The method additionally includes determining whether any hash associated with the first file matches any of the hashes associated with each other file stored in the database. When one of the hashes associated with the first file matches one of the hashes associated with a second file stored in the database, the method also includes responding to the query that the second file is similar to the first file.

### TECHNICAL FIELD

This disclosure relates to a code similarity search.

### BACKGROUND

Computer programming generally refers to the process of building a computer program to accomplish a particular computing task. To build computer programs, programmers typically generate computing instructions by coding with a computer programming language. That is programmers translate or code information from a human format to a machine format. By coding information into a machine format, the programmer is able to utilize computing resources and/or computing efficiencies offered by all different types of computing machines. Yet in a machine format or even sometimes in a human readable format, code instructions may need to be analyzed to determine whether one set of code instructions is similar to or matchers another set of code instructions.

### SUMMARY

One aspect of the disclosure provides a method for determining code similarity. The method includes receiving, at data processing hardware, a plurality of files. For each file of the plurality of files, the method also includes identifying, by the data processing hardware, executable portions of the respective file, dividing, by the data processing hardware, the identified executable portions of the respective file into code blocks, generating, for each code block of the respective file, a hash to represent the respective code block, and storing, by the data processing hardware, the respective file in a file database as a respective sequence of the bashes generated to represent the code blocks divided from the identified executable portions of the respective file. The method further includes receiving, at the data processing hardware, a query to identify whether a first file of the plurality of files stored in file database is similar to any other file stored in the file database. The method additionally includes determining, by the data processing hardware, whether any hash in the respective sequence of the hashes associated with the first file stored in the file database matches any of the hashes in the respective sequence of the hashes associated with each other file of the plurality of files stored in the database. When one of the hashes in the respective sequence of the hashes associated with the first file matches one of the hashes in the respective sequence of the hashes associated with a second file of the plurality of files stored in the file database, the method also includes generating, by the data processing hardware, a response to the query indicating that the second file is similar to the first file. In some examples, the method further includes, for each file of the plurality of files, disassembling, by the data processing hardware, the respective file from machine-executable code to assembly language source code.

Another aspect of the disclosure provides a system for determining code similarity. The system includes data processing hardware and memory hardware in communication with the data processing hardware. The memory hardware stores instructions that when executed on the data processing hardware cause the data processing hardware to perform operations. The operations include receiving a plurality of files. For each file of the plurality of files, the operation also include identifying executable portions of the respective file, dividing the identified executable portions of the respective file into code blocks, generating, for each code block of the respective file, a hash to represent the respective code block, and storing the respective file in a file database as a respective sequence of the hashes generated to represent the code blocks divided from the identified executable portions of the respective file. The operations further include receiving a query to identify whether a first file of the plurality of files stored in file database is similar to any other file stored in the file database. The operations additionally include determining whether any hash in the respective sequence of the hashes associated with the first file stored in the file database matches any of the hashes in the respective sequence of the hashes associated with each other file of the plurality of files stored in the database. When one of the hashes in the respective sequence of the hashes associated with the first file matches one of the hashes in the respective sequence of the hashes associated with a second file of the plurality of files stored in the file database, the operations also include generating a response to the query indicating that the second file is similar to the first file. In some implementations, the operations further include, for each file of the plurality of files, disassembling, by the data processing hardware, the respective file from machine-executable code to assembly language source code.

Implementations of either the method or the system disclosure may include one or more of the following optional features In some implementations, dividing the identified executable portions of the respective file into code blocks includes, for each executable portion of the identified executable portions of the respective file, identifying one or more locations in a sequence of instructions for the corresponding executable portion of the respective file and, at each location of the identified one or more locations in the sequence of instructions, designating an end of a first code block and a start of a second code block. In these implementations, the instructions may determine whether to continue the sequence of instructions or transition to another portion of the instructions at the identified one or more locations in the sequence of instructions. In some examples, identifying the executable portions of the respective file includes removing at least one non-executable portion of the respective file. In some configurations, none of the code blocks include non-executable portions of the respective file. Generating the hash to represent the respective code block may include generating the hash having a fixed length or generating the hash to use a cryptographic hash function. The hash generated using the cryptographic hash function may include a 256-bit hash. The plurality of files may include binary files.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example computing environment for a code manager.

FIGS. 2A-2C are schematic views of example code managers for the computing environment of FIG. 1.

FIG. 3 is a flow chart of an example arrangement of operations for a method of determining code similarity.

FIG 4 is a schematic view of an example computing device that may be used to implement the systems and methods described herein.

Like reference symbols in the various drawings indicate like elements.

### DETAILED DESCRIPTION

Computer code is configured for many benefits including storage, machine to human translation, computing execution, etc. Yet unfortunately, computer code is not without its setbacks. For instance, because machine code is not readily human-readable, it often proves difficult to determine whether computer code includes any malicious content. To further complicate the issue that computer code may include malicious content unbeknownst to an entity executing the computer code, a non-programmer or even a programmer may have difficulty distinguishing all the content included in a sequence of code. This is especially true when it is not uncommon for the amount of computer code to be rather large. With a significant amount of computer code, it becomes even more difficult to determine if computer code is purely good ware (referring to software devoid of malicious content) or has some degree of malware (referring to malicious software content).

Malware, which generally refers to any type of malicious software, has basically existed in the computing industry from the beginning of the internet age. Malware typically corresponds to code developed by cyber attackers to cause damage to data and/or systems or to gain unauthorized access to a network and/or computing device. Some common examples of malware include viruses, worms, ransomware, scareware, and adware/spyware, among others. One of the problems posed by malware is that malware will change during its life with multiple variances and code changes to adapt and to evolve to penetrate security defenses. Due to such constant changes, the security industry is often operating on limited information regarding malware or a family of variances of the malware. That is, the security industry may know one particular instance or snapshot of a malware family, but yet fail to know how the malware evolves or changes over time. For instance, during an infection with malware, the infected entity becomes aware of a particular variance of the malware. In other words, the infected entity sees a single sample of the malware. From a single sample, the infected entity or a security provider for the infected entity will be aware of that particular variant. Yet since this infection is only a single sample, the security provider and/or the infected entity generally lacks a true understanding of the varietal changes that may occur for the malware. Here, if the infected entity or security provider had a greater understanding of different variations of the malware (i.e., the malware family), the security provider is more likely to prevent future infections from any variance of the malware. Since gathering a sample of a malware variety tends to occur when someone is infected with malware, it is not in the security industry's best interest or a potential victim's best interest to wait to gather samples of multiple varieties for the malware in order to establish a security solution. Therefore, it is generally not easy to understand the whole coding ecosystem for a particular type of malware. Unfortunately without this understanding, victims of a malware infection may still be vulnerable to another infection by a different variety of that malware.

Given these issues, a few different approaches have developed to review computing data for malicious content. Generally speaking, computing data, such as software (e.g., whether good ware or malware) is stored in a file. A file refers to a unit of data storage that may include a collection of data. A file typically has a File name or file extension that may designate the type of data stored within the file. Types of data stored in files may include documents (e.g., text formats), media (e.g., pictures, video, or audio), libraries (e.g., plug-ins, scripts, etc.), or applications (e.g., a program or some executable file). In one approach, all of the content of a file is reviewed to determine whether all of the content of a file matches another file (e.g., a known malicious file). For instance, a file with a software program is compared to a known malware file. In another approach, one file may be compared to another file by a fuzzy hashing process that calculates the similarity between files by looking at the entirety of one file compared to the entirety of the other file. Although, both of these techniques try to evaluate some aspect of the similarity between files, both approaches fail to take into account that a malware family or malware binary has to be axle that is executed into a machine (i.e., code that infects a machine or performs some malicious execution function). What this means is that, by reviewing a file in its entirety, the review process is inherently accounting for and comparing part(s) of a file that are not executed into a machine. For example, although a file contains executable content to run an application, portions of that file for the application may also include an image (e.g., an icon representing the application), text (e.g., text describing different languages for the application), or communication pages (e.g., portable document formats (PDFs) that instructions or readme information). Malware may exploit these non-executable portions of a file to skirt around this type of entire file comparison. In other words, malware may include non-executable portions in one malware variant that are different from non-executable portions of another malware variant. Here, the different non-executable portion of a file will appear as though the file itself is different from a known malicious file even though an executable portion of the file is malicious and is the same as the known malicious file. Malware may also fool this comparative approach in a similar manner by adding or removing some non-executable portion of the file such that the entire file comparisons do not match. More generally this means that techniques to determine code similarity often occur at a level (e.g., the entire file level) that is not meaningful to the true similarity concern at hand. In other words, looking at file similarity for the entire file casts too wide of a similarity net when the true similarity concern is at the executable level of the code.

To address some of these deficiencies with file comparison, a file comparison process (referred to as a code instruction comparison) may filter out the non-executable portion(s) of a file and focus on the executable portion(s) of a file. This process therefore inspects the code instructions from a file that are the executable portions and compares these code instructions to other code instructions from another file (e.g., a known malware file). By taking this tact, this approach therefore avoids potential comparison pitfalls that may occur when non-executable portions do not match or appear similar, while also compressing the amount of review that has to occur. Particularly, by looking at the code instructions from the file, the entirety of the file does not need to be reviewed because the non-executable portions are disregarded (e.g., removed, filtered out, or programmed to be ignored). Moreover, by looking at the code instructions or executable portions of a file, the process may identify variants of a code (e.g., particular malware or versions of executable code) because the executable content of the file does not change even though other, non-executable, portions of the file may change. In other words, this comparison process identifies that a first file containing variant A of the malware is the same as a second file containing variant B of the malware because the executable portions of the first file and the second file are identical even though a non-executable portion of the first file is different from a non-executable portion of the second file. Although this code instruction comparison is capable of identifying malware, it is more broadly applicable to identify any executable similarity between codes. As such, this coding similarity approach may be used for any file comparison or code instruction comparison application such as identifying goodware, identifying copied source code, and/or identifying open source code that is similar between two files.

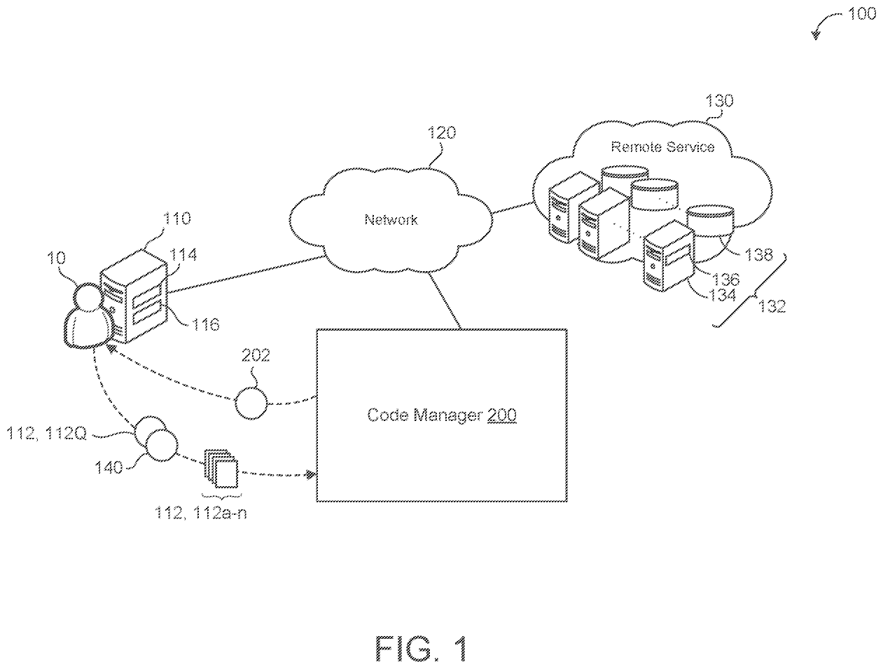

FIG. 1 is an example of a computing environment 100. A user device 110 associated with a user 10 executes data stored on one or more files 112, 112a-n. For example, the user 10 uses applications stored in the one or more files 112 that operate on the computing resources (e.g., data processing hardware 114 and/or memory hardware 116) of the user device 110. The user 10 generally corresponds to an entity that utilizes the functionality of a code manager 200 to compare code instructions of a file 112 of the user 10 to another file stored at the code manager 200 or stored in a storage database in communication with the code manager 200. For instance, the user 10 is an entity (e.g., a security provider or file user) who is concerned that at least one file 112 is infected with malware and leverages the code manager 200 to determine if that may be the case. Here, the code manager 200 may include or be in communication with a database that stores know-n malicious files that may be compared to the file 112 of the user 10 to determine whether the file 112 includes malicious content similar to the known malicious files.

In some examples, the user 10 may provide the code manager 200 with one or more files 112 to store in a database associated with the code manager 200. By providing a file 112, the user 10 is contributing to a compilation of files (e.g., a file repository) that may be compared to each other or other files 112 presented to the code manager 200. In some implementations, the code manager 200 is configured to receive files 112 and/or compare files from multiple users 10 in order to build a robust database for file comparison. In some configurations, when the user 10 contributes a file 112 to the code manager 200, the code manager 200 may be configured to subsequently communicate with the user 10 if the code manager 200 later receives or recognizes a file 112 with similar or matching code instructions to that of a file 112 contributed by the user 10.

The device 110 is configured to communicate file(s) 112 and to query the code manager 200 to perform file comparison. The device 110 may correspond to any computing device associated with the user 10 and capable of accessing the code manager 200 and utilizing its functionality to analyze files 112. Some examples of a user devices 110 include, but are not limited to, mobile devices (e.g., mobile phones, tablets, laptops, e-book readers, etc.), computers, wearable devices (e.g., smart watches), casting devices, internet of things (IoT) devices, smart speakers, etc. The device 110 includes the data processing hardware 114 and the memory hardware 116 in communication with the data processing hardware 114 and storing instructions, that when executed by the data processing hardware 114, cause the data processing hardware 114 to perform one or more operations related to file communication or file comparison.

In some implementations, the user device 110 is a local device (e.g., associated with a location of the user 10) that uses its own computing resources (e.g., the data processing hardware 114 and/or memory hardware 116) with the ability to communicate (e.g., via the network 120) with one or more remote systems 130 (e.g., a cloud computing environment). Much like the user device 110. the remote system 130 includes computing resources 132 such as remote data processing hardware 134 (e.g., server and/or CPUs) and remote memory hardware 136 (e.g., disks, databases, or other forms of data storage). The user device 110 may leverages its access to remote resources (e.g., remote computing resources 132) to operate applications for the user 10. These applications may refer to applications stored in one or more files 112 of the user 10 or the axle manager 200 itself. For example, the code manager 200 may be an application hosted on the remote system 130 that is accessible to the user device 110 of the user 10 (e.g., via a web browser application). In some configurations, the code manager 200 is a local application stored on the memory hardware 116 and executed by the data processing hardware 114 of the device 110. When the code manager 200 is located locally or remotely, the code manager 200 may be in communication with the remote system 130 to access one or more files 112 for comparison. For instance, the remote system 130 includes a database or other file repository located in its remote memory hardware 136 that stores files 112 for comparison at the code manager 200. Files 112 of the user 10 may be initially stored locally (e.g., in the memory hardware 116) and then communicated to the remote system 130 or sent prior to some execution or function at the user device 110.

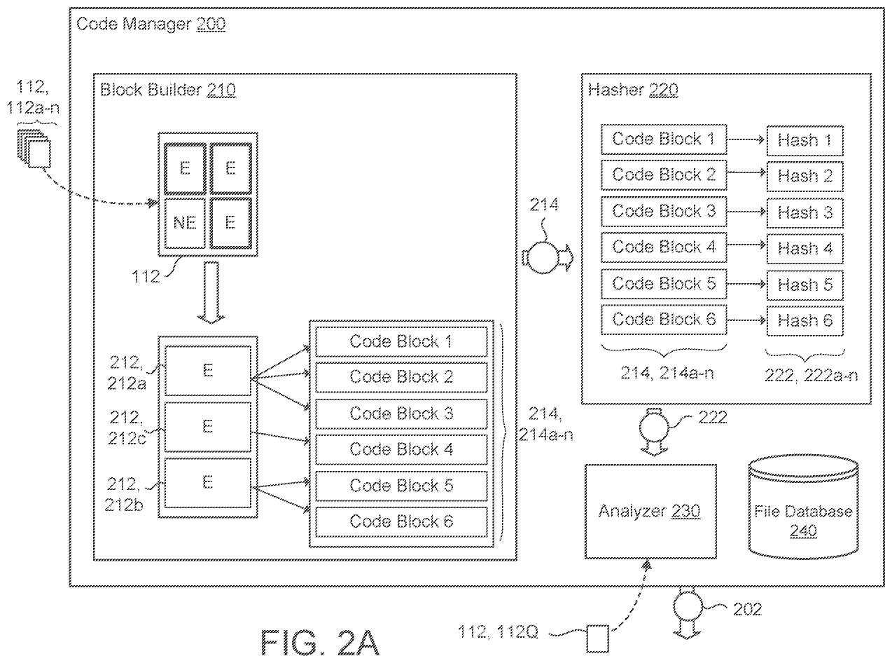

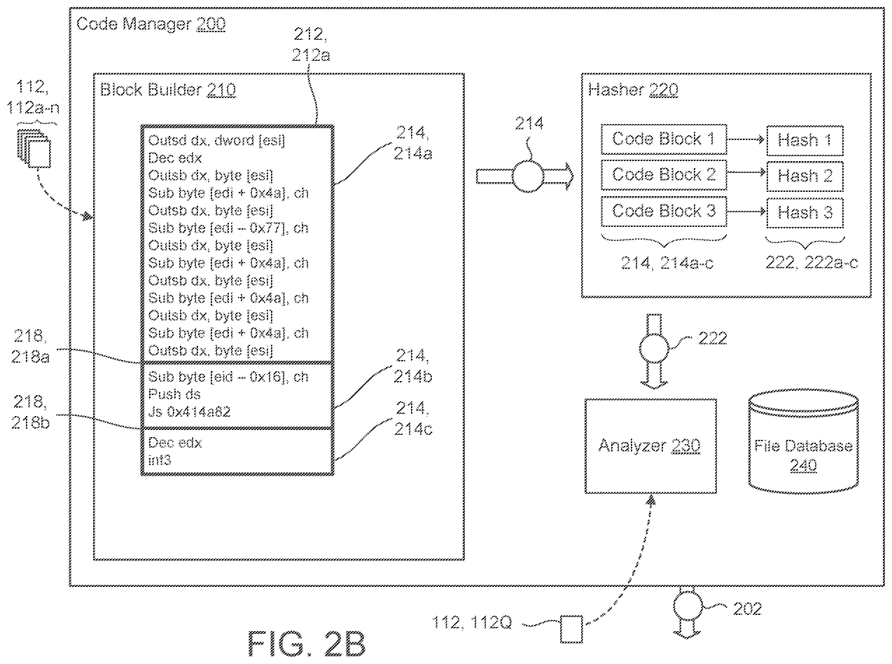

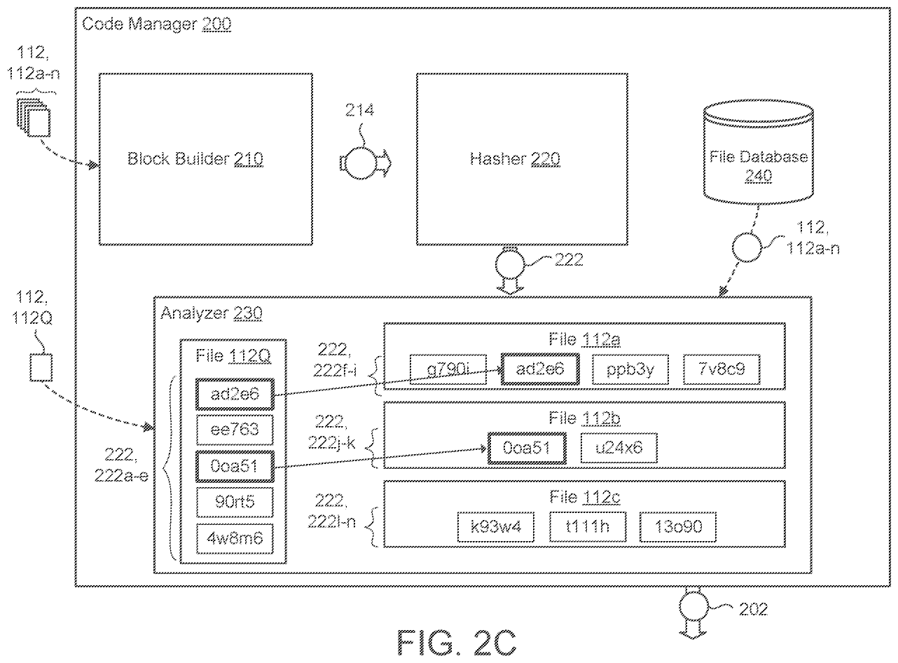

With continued reference to FIG. 1, the user 10 may generate a query 140 and communicate the query 140 to the code manager 200. The query 140 refers to a request for the code manager 200 to identify whether a file 112 is similar to any other file 112 located in a file database (FIGS. 2A-2C) of the code manager 200. In some examples, the user 10 communicates a file 112 (also referred to as a query file 112Q) for comparison along with the query 140 and asks whether the file 112 associated with the query 140 is similar to (or matches) any other file in the file database of the code manager 200. For instance, the query file 112Q may be owned or associated with the user 10 and the user 10 queries the code manager 200 with the query file 112Q to prompt the code manager 200 to initiate its comparison process. The code manager 200 is configured to generate a response 202 to the query 140 that indicates whether a file 112 (e.g., the query file 112Q) matches or is similar to any other file 112 in the file database 240 of the code manager 200. When the query file 112Q of the query 140 is similar to another file, the code manager 200 generates a response 202 for the user 10 that identifies this similarity.

In some examples, the response 202 additionally includes other descriptors or information about the two files 112 or the similarity between the two files 112. For instance, if the query file 112 is similar to a known malicious file 112, the code manager 200 may provide a response 202 that includes further feedback about the known malicious file. In some implementations, the code manager 200 identifies a plurality of files 112 in the file database that are similar to the query file 112Q. Here, the response 202 generated by the code manager 200 when multiple files 112 have a similarity to the query file 112Q is similar to the of a single file 112 being similar to the query file 112Q.

Referring to FIGS. 2A-2C, the code manager 200 includes a block builder 210 (also referred to as a builder 210), a hasher 220, an analyzer 230, and a code database 240. The builder 210 is configured to receive a file 112 (e.g., a query file 112Q from the user 10 or the code manager 200) and to identify executable portions 212, 212a-n of the respective file 112. To illustrate, FIG. 2A depicts the builder 210 receiving a file 112 where the file 112 includes executable portions 212, 212a-c (also labeled E) and non-executable portions NE. Here, the file 112 includes three executable portions 212a-c and one non-executable portions NE. After identifying the executable portions 212 of the file 112, the builder 210 divides the executable portions 212 of the file 112 into code blocks 214. In some examples, the builder 210 removes the non-executable portions NE of the file 112 and aggregates the executable portions 212 of the file 112 into a structure consisting of only the executable portions 212 of the file 112. This removal of the non-executable portions NE and aggregation of the executable portions 212 may occur as an intermediary step prior to dividing the executable portions 212 of the file 112 into code blocks 214. In other examples, the builder 210 is configured to disregard or to filter out the non-executable portions N without removing the non-executable portions NE in order to divide the executable portions 212 of the file 112 into code blocks 214.

In some examples, the code manager 200 receives the file 212 as, or converts the file 112 into, a binary file. While a file typically refers to a named collection of related information that generally appears to the user 10 as a single, continuous block of data in storage, a binary file is an encoded form of a file that is a sequence of binary digits or bits. For instance, a binary file is often a sequence of bytes where each byte is a grouping of eight bits. A binary file may be any file that contains at least some data that consists of a sequence of bits that do not represent plain text. This means that binary files may be used for media (e.g., images, audio, or video), executable programs, and/or compressed data. Often times, binary files are a compact means of storing data because of the file information being represented as bits. Moreover, binary files are a convenient file form for stored programs or applications because a program stored in binary form can execute rather quickly. the encoding or formatting process that converts a file into a binary file may be a proprietary encoding process (e.g., unique to particular hardware or software) or a publicly available encoding process (e.g., an open source encoding process). By encoding a file 112 into a binary format, the binary file 112 is not in a human-readable format.

In some configurations, the code manager 200 accounts for the fact that a binary file may be uniquely compiled for different architectures. Due to this fact, the code manager 200 may instead of reviewing a file 112 at a binary level, review a file based on an assembly level. In other words, the binary level may refer to machine code particular to a specific architecture and instead of simply analyzing the file 112 for similarity with respect to that specific architecture, the builder 210 is configured to convert a binary file from its machine executable code language into an assembly code language. By performing this abstraction, the code manager 200 may determine whether an executable portion 212 of a file 112 matches an executable portion 212 of another file 112 without necessarily being limited to a single machine architecture. When the builder 210 disassembles the file 112 into an assembly file format, the builder 210 and other components of the code manager 200 perform their functionality at the assembly level.

In some implementations, such as FIG. 2B, the builder 210 divides the executable portions 212 of the file 112 into code blocks 214 by identifying split points 218, 218a-n within the executable portions 212 of the file 112. For example, the builder 210 is configured such that the split points 218 refer to logical locations where coding instructions of the executable portions 212 have an execution break or pause. The execution break or pause may refer to a location in the sequence of instructions for an executable portion 212 of the file 112 where the instructions determine whether to continue the sequence of instructions or to transition to another portion of the instructions. Therefore, in some examples, when there is a deterministic or non-deterministic jump to the execution flow, the builder 210 terminates a prior code block-214 and begins a new code block 214. In the example shown in FIG 2B, the builder 210 divides an executable portion 212a of the file 112 into three code blocks 214a-c. The first code block 214a begins at the start of the executable portion 212 of the file 112 and ends at the first split point 218, 218a in the sequence of instructions for the executable portion 212a of the file 112. The second code block 214b begins at the first split point 218a and ends at a second split point 218b. The third code block 214c begins at the second split point 218c and ends at the end of the executable portion 212a

The builder 210 communicates each code block 214 for a file 112 to the hasher 220. For each code block 214 received from the builder 210, the hasher 220 is configured to generate a hash 222 (also referred to as a hash value or digest) or unique string of values/characters (e.g., alpha-numeric values) The hasher 220 may be configured to use a variety of hashing functions or hashing, algorithms to generate the hash 222. Generally speaking, hashes 222 are often irreversible such that one cannot reconstruct the executable portions 212 of the file 112 using the hash 222. A hash function of the hasher 220 operates such that if two identical code blocks 214 exist, the hasher 220 would assign each code block 214 the same hash 222. From this perspective, code blocks 214 of a file 112 represented by hashes 222 may be compared to code blocks 214 of another file 112 by comparing each file's hashes 222. By using hashes 222, the code manager 200 does not need to evaluate the actual content of the file 112, but rather focus on hashes 222 corresponding to a file 112 generated by the hasher 220. Since each hash 222 represents a code block 214 corresponding to an executable portion 212 of the file 112, when the code manager 200 compares hashes 222, the code manager 200 is comparing executable portions 212 of the file 112. In other words, this hash comparison leverages the actual coding instructions for a file 112 rather than the entire file 112 more generally, allowing the comparison to be a more specific sub-file level comparison.

Some hash algorithms are secure hash algorithms (SHAs) or also known as cryptographic hash functions. A cryptographic hash function refers to a one-way compression function that aims to prevent any reversibility of the hash 222 (e.g., to the original content input into the hash function). Some examples of secure hash algorithms include SHA-0. SHA-1. SHA-2, and SHA-3. As discussed further, cryptographic hash functions, like other hash functions, may be configured to generate hash values of a fixed length (e.g., a fixed number of bits such as 224-bits, 256-bits. 384-bits, 512-bits, among others). For instance, SHA256 is a secure hash algorithm that generates a 256-bit hash

In some implementations, the hasher 220 enables the analyzer 230 to perform uniform comparison between code blocks 214. What this means is that code blocks 214 may be of variable size, especially when code blocks 214 are dependent on the amount of execution instructions that occur before/after a split location 218. With variable-sized code blocks 214, the comparison performed by the code analyzer 230 of the code manager 200 may have a difficult time comparing code blocks 214 of different sizes. To avoid this scenario, the hasher 220 may generate a fixed-length hash 222 for each code block 214. With a fixed-length code block 214 instead of a variable-length code block 214, the analyzer 230 will have a greater ease of comparison. Furthermore, by having a fixed-length code block 214 instead of a variable-length code block 214, the code manager 200 may analyze files 112 more efficiently and/or store files 112 converted to code blocks 214 more effectively (e.g., by having a general idea of a size need to store a given hash 222).

When the hasher 220 represents the code blocks 214 of the file 112 as hashes 222, the hasher 220 may be configured to communicate the file 112 as a sequence of hashes 222 to the file database 240 for storage. When the file database 240 receives the file 112 from the hasher 220, the file database 240 is configured to store the file 112 as a sequence of hashes 222 corresponding the code blocks 214 representing executable portions 212 of the file 112. The file database 240 may be integrated with the code manager 200 or separate from the code manager 200 (or one or more components of the code manager 200) yet in communication with the code manager 200. In either configuration, the file database 240 may function as a file repository that stores any number a files 112 (e.g., as a sequence of hashes 222) for the user 10 and/or other users with access to the file database 240. In this sense, the file database 240 may operate as a library of files 112 that the user 10 may access using the code manager 200 to determine if a query file 112Q matches one or more files 112 within the file database 240. When the file database 240 serves as a central repository or library, the file database 240 may be a robust source (e.g., a community resource) to store stored content, such as known malware, goodware, open source code, etc., for code similarity comparison (i.e., to allow a user 10 to identify whether a query file 112Q is similar to the stored content).

In some examples, when a file 112 is sent to the file database 240, the file database 240 or the sender of the file 112 may label the file 112 with a descriptor to identify a characteristic of the file 112. For example, a security provider sends known malicious files 112 to store in the file database 240 and labels those files 112 in some manner to indicate that those files 112 are malicious files 112. Therefore, when a user 10 generates a query 140 with a query file 112Q, if the code manager 200 identifies that the query file 112Q matches (or is similar to) one of these known malicious files 112, the code manager 200 may return a response 202 with the descriptor of the known malicious files 112 to the user 10 that identifies that the query file 112Q matches a known malicious file 112.

The analyzer 230 is configured to receive a file 112 represented by a sequence of hashes 222 corresponding to the code blocks 214 of the file 112 and to compare each hash 222 within the sequence of hashes 222 to hashes 222 associated with one or more other files 112. In some examples, the analyzer 230 receives a query file 112Q (e.g., from the user 10) and compares this query file 112Q to other files 112 stored in the file database 240 (e.g., all stored files or some portion thereof). When the analyzer 230 performs this comparison, the analyzer 230 is configured to identify a hash 222 of the query file 112Q and to review the hashes 222 of each stored file 112 to determine whether the hash 222 of the query file 112Q matches any hashes 222 of the stored filet(s) 112. The analyzer 230 continues this process for each hash 222 of the query file 112Q and comparing each hash 222 to the hashes 222 of the stored files 112 at the file database 240. When a hash 222 of the query file 112Q matches a hash 222 of one or more files 112 stored in the file database 240, the analyzer 230 determines that query file 112Q is similar (i.e., has code similarity) to each file 112 with a hash 222 that matches a hash 222 of the query file 112Q. In other words, the analyzer 230 determines these files 112 are similar because a matching hash 222 means that the files 112 contain matching code blocks 214 corresponding to matching executable portions 212. Therefore, the files 112 are similar in the sense that some executable portion 212 of query file 112Q is the same as some executable portion 212 of the matching file 112. With this process, the analyzer 230 is able to determine whether specific executable portions 212 of a file 112 have code instructions that match executable portions 212 of another file 112. Although not all of the content of a query file 112 may match another file 112, the analyzer 230 communicates a response 202 that the files 112 are similar because some executable portion 212 of each file 112 matches.

FIG. 2C is a small, but scalable, example that illustrates the analyzer 230 receiving a query file 112Q with a sequence of five hashes 222, 222a-e. The analyzer 230 identifies the first hash 222a of the query file 112Q and compares this first hash 222a to hashes 222, 222f-n associated with three stored files 112, 112a-c. Here, the analyzer 230 determines that the first hash 222a matches a seventh hash 222g associated with the first stored file 112a. Once the analyzer 230 has completed analysis for the first hash 222a of the query file 1120. the analyzer 230 proceeds to the second hash 222b of the query file 112Q. During its analysis for the second hash 222b of the query file 112Q, the analyzer 230 does not identify any hashes 222 associated with the three stored files 112a-c that match the second hash 222b of the query file 112Q. Following its analysis of the second hash 222b of the query file 112Q, the analyzer 230 proceeds to the third hash 222c of the query file 112Q and analyzes whether the third has 222c matches any hashes 222f-n associated with the three stored files 112a-c. While analyzing the third hash 222c, the analyzer 230 determines that a tenth hash 222j of the second stored file 112b matches the third hash 222c of the query file 112Q. After completion of its analysis of the third hash 222c, the analyzer 230 proceeds in a similar analysis manner to determine whether the fourth hash 222d and the fifth hash 222e match any hashes 222f-n of the three stored files 112a-c. In the example shown, neither the fourth hash 222d nor the fifth hash 222e match any hashes 222f-n associated with the stored files 112a-c. Based on this process, the analyzer 230, and/or the code manager 200 more generally, returns a response 202 to the user 10 that indicates that the first stored file 112a and the second stored file 112b are similar to the query file 112Q. Although FIG 2C illustrates a single hash 222 of the query file 112Q matching a single hash 222 of a stored file 112, a hash 222 of the query file 112Q may match multiple hashes 222 within the same stored file 112 or may match multiple hashes 222 among different stored files 112. In some configurations, the response 202 includes extra detail regarding the analysis by the analyzer 230. For example, the response 202 details which specific hash 222 of the query file 112Q had matches and/or known information about the similar stored files 112a-b. For instance, the response 202 identifies that the first stored file 112a is a known malicious file and the second stored file is a known goodware file (e.g., if this information is accessible to the code manager 200). Although this process is discussed as sequentially stepping through each hash 222 of the query file 112Q, the analyzer 230 may utilize computing resources to analyze multiple hashes 222 in parallel computing operations. Moreover, the functionality of the code manager 200 is scalable to review a large repository of stored files 112 and to analyze, at the analyzer 230, whether there is any file similarity.

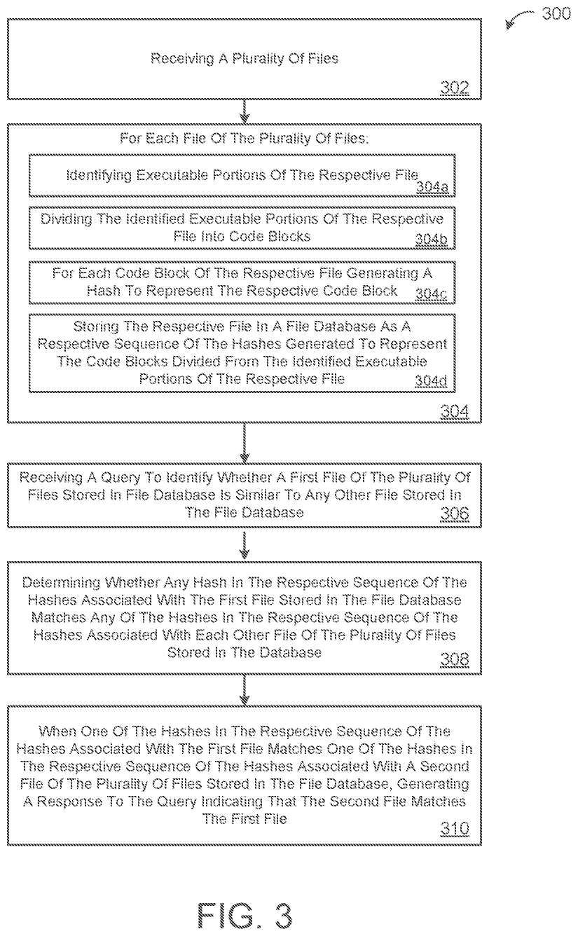

FIG 3 is a flowchart of an example arrangement of operations for a method 300 of determining code similarity. At operation 302, the method 300 receives a plurality of files 112, 112a-n. At operations 304, the method 300 performs sub-operations 304a-d for each file 112 of the plurality of files 112a-n. At operation 304a, the method 300 identifies executable portions 212 of the respective file 112. At operations 304b, the method 300 divides the identified executable portions 212 of the respective file 112 into code blocks 214. At operation 304c, the method 300 generates, for each code block 214 of the respective file 112, a hash 222 to represent the respective code block 214. At operation 304d, the method 300 stores the respective file 112 in a file database 240 as a respective sequence of the bashes 222 generated to represent the code blocks 214 divided from the identified executable portions 212 of the respective file 112. At operation 306, the method 300 receives a query 140 to identify whether a first file 112, 112Q of the plurality of files 112a-n stored in file database 240 is similar to any other file 112 stored in the file database 240. At operation 308, the method 300 determines whether any hash 222 in the respective sequence of the hashes 222 associated with the first file 112Q stored in the file database 240 matches any of the hashes 222 in the respective sequence of the hashes 222 associated with each other file 112 of the plurality of tiles 112a-n stored in the database 240. At operation 310, when one of the hashes 222 in the respective sequence of the hashes 222 associated with the first file 112Q matches one of the hashes 222 in the respective sequence of the hashes 222 associated with a second file 112 of the plurality of files 112a-n stored in the file database 240, the method 300 generates a response 202 to the query 140 indicating that the second file 112 is similar to the first file 112Q.

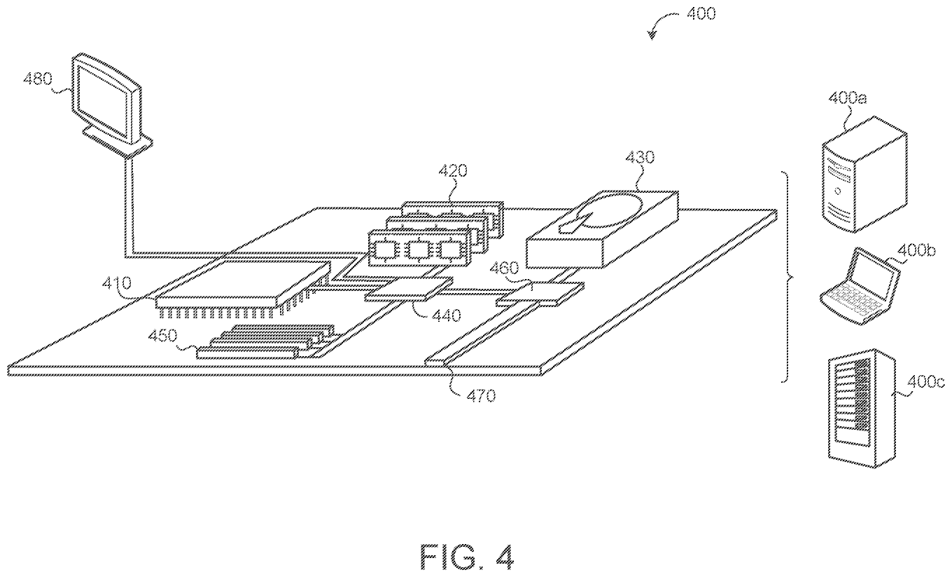

FIG. 4 is schematic view of an example computing device 400 that may be used to implement the systems (e.g., the code manager 200) and methods (e.g., the method 300) described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (e.g., data processing hardware), memory 420 (e.g., memory hardware), a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to. flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network, or oilier configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by. or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described Nevertheless, it will be understood that various modifications may be made without departing from the spirit and scope of the disclosure. Accordingly, other implementations are within the scope of the following claims.

What is claimed is:

1. A method comprising:
receiving, at data processing hardware, a plurality of files;
for each file of the plurality of files:
identifying, by the data processing hardware, executable portions of the respective file;
dividing, by the data processing hardware, the identified executable portions of the respective file into code blocks;
for each code block of the respective file, generating, by the data processing hardware, a hash to represent the respective code block; and
storing, by the data processing hardware, the respective file in a file database as a respective sequence of the hashes generated to represent the code blocks divided from the identified executable portions of the respective file,
receiving, at the data processing hardware, a query to identify whether a first file of the plurality of files stored in file database is similar to any other file stored in the file database;
determining, by the data processing hardware, whether any hash in the respective sequence of the hashes associated with the first file stored in the file database matches any of the hashes in the respective sequence of the hashes associated with each other file of the plurality of files stored in the database; and
when one of the hashes in the respective sequence of the hashes associated with the first file matches one of the hashes in the respective sequence of the hashes associated with a second file of the plurality of files stored in the file database, generating, by the data processing hardware, a response to the query indicating that the second file is similar to the first file.

2. The method of claim 1, wherein dividing the identified executable portions of the respective file into code blocks comprises, for each executable portion of the identified executable portions of the respective file;
identifying one or more locations in a sequence of instructions for the corresponding executable portion of the respective file; and
at each location of the identified one or more locations in the sequence of instructions;
designating an end of a first code block; and
designating a start of a second code block.

3. The method of claim 2, wherein, at the identified one or more locations in the sequence of instructions, the instructions determine whether to continue the sequence of instructions or transition to another portion of the instructions.

4. The method of claim 1, wherein identifying the executable portions of the respective file comprises removing at least one non-executable portion of the respective file.

5. The method of claim 1, wherein generating the hash to represent the respective code block comprises generating the hash having a fixed length.

6. The method of claim 1, wherein the plurality of files comprise binary files.

7. The method of claim 1, further comprising, for each file of the plurality of files, disassembling, by the data processing hardware, the respective file from machine-executable code to assembly language source code.

8. The method of claim 1, wherein generating the hash to represent the respective code block comprises generating the hash using a cryptographic hash function.

9. The method of claim 8, wherein the hash generated using the cryptographic hash function comprises a 256-bit hash.

10. The method of claim 1, wherein none of the code blocks include non-executable portions of the respective file.

11. A system comprising:
data processing hardware; and
memory hardware in communication with the data processing hardware, the memory hardware storing instructions that when executed on the data processing hardware cause the data processing hardware to perform operations comprising:
receiving a plurality of files;
for each file of the plurality of files;
identifying executable portions of the respective file;
dividing the identified executable portions of the respective file into code blocks;
for each code block of the respective file, generating a hash to represent the respective code block; and
storing the respective file in a file database as a respective sequence of the hashes generated to represent the code blocks divided from the identified executable portions of the respective file;
receiving a query to identify whether a first file of the plurality of files stored in life database is similar to any other file stored in the file database;
determining whether any hash in the respective sequence of the hashes associated with the first file stored in the file database matches any of the hashes in the respective sequence of the hashes associated with each other file of the plurality of files stored in the database, and
when one of the hashes in the respective sequence of the hashes associated with rite first file matches one of the hashes in the respective sequence of the hashes associated with a second file of the plurality of files stored in the file database, generating a response to the query indicating that the second file is similar to the first file.

12. The system of claim 11, wherein dividing the identified executable portions of the respective file into code blocks comprises, for each executable portion of the identified executable portions of the respective file;
identifying one or more locations in a sequence of instructions for the corresponding executable portion of the respective file; and
at each location of the identified one or more locations in the sequence of instructions;
designating an end of a first code block; and
designating a start of a second code block.

13. The system of claim 12, wherein, at the identified one or more locations in the sequence of instructions, the instructions determine whether to continue the sequence of instructions or transition to another portion of the instructions.

14. The system of claim 11, wherein identifying the executable portions of the respective file comprises removing at least one non-executable portion of the respective file.

15. The system of claim 11, wherein generating the hash to represent the respective code block comprises generating the hash having a fixed length.

16. The system of claim 11, wherein the plurality of files comprise binary files.

17. The system of claim 11, wherein the operations further comprise, for each file of the plurality of files, disassembling the respective file from machine-executable code to assembly language source code.

18. The system of claim 11, wherein generating the hash to represent the respective code block comprises generating the hash using a cryptographic hash function.

19. The system of claim 18, wherein the hash generated using the cryptographic hash function comprises a 256-bit hash.

20. The system of claim 11, wherein none of the code blocks include non-executable portions of the respective file.
